(19) United States
(12) Patent Application Publication
(10) Pub. No.: US 2016/0031027 A1
(43) Pub. Date: Feb. 4, 2016

(54) Method For Applying Brazing Material To Metal Honeycomb Matrix, Metal Honeycomb Matrix And Manufacturing Method Thereof

(71) Applicants: Gengsheng Chu, Guangxi (CN); Shuiping Deng, Guangxi (CN); Yuqin Zhang, Guangxi (CN); Ye Liu, Holmdel, NJ (US); Weichang Tao, Guangxi (CN); Peter Bartholomaeus, Shanghai (CN)

(72) Inventors: Gengsheng Chu, Guangxi (CN); Shuiping Deng, Guangxi (CN); Yuqin Zhang, Guangxi (CN); Ye Liu, Holmdel, NJ (US); Weichang Tao, Guangxi (CN); Peter Bartholomaeus, Shanghai (CN)

(73) Assignee: BASF Corporation, Florham Park, NJ (US)

(21) Appl. No.: 14/342,730

(22) PCT Filed: Sep. 5, 2011
(86) PCT No.: PCT/CN2011/079322

§ 371 Date: Dec. 8, 2014

(51) Int. Cl. B23K 1/00; B23K 35/30; B23K 35/02

(52) U.S. Cl. CPC B23K 1/0014; B23K 35/025; B23K 35/304

(57) ABSTRACT

A method for applying brazing material to a metal honeycomb matrix is provided. The method comprises the following steps of: a) applying a brazing material in a paste form, i.e., a solder paste, to one end face of the metal honeycomb matrix; b) distributing the solder paste in the metal honeycomb matrix. A metal honeycomb matrix and a method for manufacturing the metal honeycomb matrix are also provided.

### TECHNICAL FIELD

In summary, the invention relates to a method for applying brazing material to metal honeycomb matrix, a method for manufacturing metal honeycomb matrix and the metal honeycomb matrix.

### BACKGROUND ART

Metal honeycomb matrices, which are usually used as substrates of catalysts in the exhaust gas systems of vehicles, have a housing with two open end faces, often in a cylindrical form, and a honeycomb core within the housing. The honeycomb core is generally constructed by stacking and winding up smooth and corrugated metal sheets.

The smooth and corrugated metal sheets or foils, as well as the honeycomb core and the housing, are usually joined together with brazing material via, e.g., vacuum brazing techniques.

In the current published technologies, many methods for applying brazing materials and for constructing metal honeycomb matrices have been disclosed. The methods described in the US 2001/0013390 A1, US 2004/0217149 A1, US 2005/0092779 A1 and US 2007/0040004 A1 patent applications include separate application of adhesive and brazing powder, i.e., applying adhesive prior to winding the smooth and corrugated metal sheets or foils, followed by applying brazing powder after winding or even after the honeycomb core have been incorporated into the housing, which will be secured on the metal walls by the adhesive. However, such methods of separate application of adhesive and brazing powder have the following disadvantages. Since the powder brazing material is usually not homogenously distributed in the adhesive, the metal sheets or foils are not sufficiently firmly welded, and consequently honeycomb matrix may have poor heat-resistance. Besides, these methods comprise too many steps and sizing followed by coiling easily leads to incompact coiling, which will affect the follow-up welding quality.

The U.S. Pat. No. 4,521,947 patent discloses a method, wherein the smooth and the corrugated steel sheets are initially coiled to form a cylindrical honeycomb element, and thereafter either a soldering paste consisting of soldering powder and binding agent with suitable viscosity is applied, with a roller, to one or both end faces of the wound-up honeycomb element or a predetermined amount of solder is injected by a soldering-injection gun to one end face of the wound-up honeycomb element. However, the roller can only distribute the soldering paste to the end faces of the honeycomb element but not the middle area of the honeycomb. Additionally, the method is difficult to provide a uniform soldering paste distribution, and to apply the paste to the desired areas.

CN 2861504Y discloses a metal honeycomb matrix for waste gas purifying catalyst which comprises a flat plate and a waveform plate attached each other. The said metal honeycomb is constructed by first positioning the brazing strips on the upper surfaces of the flat and waveform plates, mutually aligning the upper and lower solder strips, and then coiling or stacking them into a honeycomb core. However, the problem with the way of using the solder strips is that the area covered by the brazing material is not all used for brazing which, on one hand, results in a waste of brazing materials, and on the other hand, the residual brazing material may reduce the area of cells inside the matrix, decrease the gas flow and increase the backpressure.

Therefore, the current published technologies have technical drawbacks and cannot provide metal honeycomb matrices with good heat-resistance property. The drawbacks also include over many steps, wasting of brazing materials and reducing of cell area inside the matrix.

To overcome the problems in the current published technologies, new methods are still needed for easily manufacturing the honeycomb matrix.

### BRIEF DISCLOSURE OF THE INVENTION

The present invention includes a method for applying brazing material to a metal honeycomb matrix, a method for manufacturing the metal honeycomb matrix and the metal honeycomb matrix prepared by the method of the present invention. To be specific, the present invention includes the following aspects:

1. A method for applying brazing material to a metal honeycomb matrix having two open end faces, which contains a metal housing and a metal honeycomb core constructed by stacking and winding up smooth and corrugated metal sheets, comprising the steps of

a) applying the brazing material in a paste form, i.e., a solder paste, to one end face of the metal honeycomb matrix;

c) distributing the solder paste in the metal honeycomb matrix.

2. The method according to the above 1, wherein the solder paste is applied in a predetermined amount in step a).

3. The method according to above 1 or 2, wherein the solder paste is applied by coating, such as, brush coating, knife coating, wash coating or spray coating, or by using a dispenser or grouter in step a).

4. The method according to any one of 1 to 3, wherein the solder paste is distributed in the contact joints of the corrugated sheets and smooth sheets and/or the housing by step c).

5. The method according to any one of the above 1 to 4, wherein the solder paste is present in a predetermined area in the metal honeycomb matrix.

6. The method according to any one of the above 1 to 5, wherein the step c) is carried out by means of airflow purging or centrifugation.

7. The method according to the above 6, wherein the airflow purging is carried out by using compressed air.

8. The method according to the above 6 or 7, wherein the airflow purging is carried out for from 2 to 10 seconds under a gas pressure of from 0.2 to 0.6 MPa gauge pressure.

9. The method according to the above 6, wherein the centrifugation is carried out for from 2 to 10 seconds at a speed of from 200 to 2000 rpm.

10. The method according to any one of the above 1 to 9, wherein the solder paste is distributed in the single-ended form, in the warhead-like form or in the form of complete distribution.

11. The method according to any one of the above 1 to 10, further comprising a step of precleaning the metal honeycomb matrix prior to step a).

12. The method according to any one of the above 1 to 11, further comprising, between steps a) and c), the following step of:

b) leaving the metal honeycomb matrix to stand, allowing the applied solder paste to move from the end face to which the solder paste was initially applied to the other end face under the action of gravity.

13. The method according to the above 12, wherein the metal honeycomb matrix is left to stand for from 1 to 30 minutes in step b).

14. The method according to the above 12 or 13, wherein the metal honeycomb matrix is placed vertically or obliquely in step b).

15. The method according to any one of the above 1 to 14, wherein said solder paste comprises a solder powder and an adhesive, and has a solid content of from 15 to 60 wt. %.

16. The method according to any one of the above 1 to 15, wherein said solder paste is BNi-2 or BNi-5 or BNi-7 or other mushy brazing materials.

17. A method for manufacturing a metal honeycomb matrix with two open end faces, which contains a metal housing and a honeycomb core constructed by stacking and winding up smooth and corrugated metal sheets, comprising the steps of

(1) applying a brazing material to the metal honeycomb matrix according to the method in any one of the above 1 to 16; and

(2) brazing the metal honeycomb matrix comprising the brazing material.

18. The method according to the above 17, wherein the step (2) is carried out by vacuum brazing.

19. The method according to the above 18, wherein said vacuum brazing comprises, under the condition of from 1*10⁻³ to 2*10⁻² Pa, raising the temperature to from 950 to 1200° C. and maintaining at said temperature for from 10 to 30 minutes.

20. A metal honeycomb matrix prepared by the method according to any one of the above 16 to 18.

### BRIEF DESCRIPTION OF FIGURES

FIG. 1 shows the method in the prior art for manufacturing metal honeycomb matrix by using brazing strips.

FIG. 2 shows the solder distribution in the metal honeycomb matrix mainly at welding joints in the present invention.

FIG. 3 shows an embodiment of applying the solder paste in the method of the present invention.

FIG. 4 shows an embodiment of airflow purging used in the methods of the present invention.

FIG. 5 illustrates distribution of the solder paste in the axial section of the metal honeycomb matrix of the present invention.

FIG. 6, FIG. 7 and FIG. 8 give the three types of distribution of solder paste in the present invention, in which FIG. 6 illustrates the single-ended distribution, FIG. 7 illustrates the distribution in the warhead-like form, and FIG. 8 illustrates the complete distribution.

FIG. 9 shows the method for manufacturing the metal honeycomb matrix in the Comparative Example.

FIG. 10 shows the structure of the metal honeycomb matrix in the Comparative Example.

FIG. 11 shows the reactor used in the Performance Test and Comparison 1.

FIG. 12 shows the pictures of the catalysts after testing in the Performance Test and Comparison 1, in which FIG. 12-a to FIG. 12-c show the pictures of the catalysts using the matrices of Example 1 after a 22.5-hour endurance cycle, and FIG. 12-d to FIG. 12-f show the pictures of the catalysts using the matrices of the Comparative Example after a 4.5-hour endurance cycle.

FIG. 13 shows the axial section of the matrices of Example 2 and Comparative Example, in which FIG. 13-a is the matrix of Comparative Example, and FIG. 13-b is the matrix of Example 2.

FIG. 14 shows the pictures of the matrices after endurance test in the Performance Test and Comparison 2, in which FIG. 14-a is for the catalyst in Comparative Example after a 125-hour test, and FIG. 14-b is for the catalyst in Example 2 after a 250-hour test.

FIG. 15 gives the data of mechanical strength tests of the matrices in Example 3 and Comparative Example in the Performance Test and Comparison 3 before and after high temperature (1100° C./4 h) treatment.

### DESCRIPTION OF REFERENCE SIGNS

1—smooth sheets,
2—corrugated sheets,
3—brazing strips,
4—solder paste,
5—wound-up metal honeycomb,
6—solder paste perfusion apparatus,
7—high-pressure air nozzle,
8—brazing distribution area,
10—metal honeycomb core,
11—metal housing,
12, 13, 15—three temperature measuring points before, within and after the catalyst,
14—reactor, with catalyst therein,
16—engine

### EMBODIMENTS

Metal honeycomb matrices, which are usually used as catalyst supports for purifying exhaust gas of vehicles, contain a metal housing without closing end faces, the cross section of which is often in a round, rectangle or elliptical shape, and a metal honeycomb core constructed by stacking and winding up smooth and corrugated metal sheets. The wound-up honeycomb core is then installed into the housing. The smooth and corrugated metal sheets or foils, as well as the honeycomb core and the housing, are usually joined together with brazing materials. The metal honeycomb matrices obtained in such a way have two open end faces, and between the smooth and corrugated metal sheets or foils, as well as between the honeycomb core and the housing form hollow cells, through which gas may pass. Afterwards, the active component of catalyst is supported on the matrix to form a catalyst eventually. Said catalyst is put in the exhaust gas passage of vehicles, and once the exhaust gas passes by, it will contact the active component and is purified catalytically.

The first aspect of the present invention relates to a method for applying brazing material to the metal honeycomb matrix as stated above. The metal honeycomb matrix here means a matrix containing a metal housing and a metal honeycomb core, and smooth metal sheets, corrugated metal sheets and the housing are neither welded together yet, nor applied with any brazing materials. Said method comprises the following steps of:

a) applying a brazing material in a paste form, i.e., a solder paste, to one end face of the metal honeycomb matrix;

c) distributing the solder paste in the metal honeycomb matrix.

The metal honeycomb matrix to which the brazing material is applied according to the inventive method can be manufactured by stacking and winding up the smooth and corrugated metal sheets to form a honeycomb core, and then loading the honeycomb core into the housing, the cross section of which may be in a round, rectangle or elliptical shape. The coiling of the honeycomb may be conducted in a known manner in the art, and the wound-up core may be in a single spiral shape or S shape.

In step a) of the method of the present invention, the brazing materials are applied in the form of a paste. In one embodiment, said solder paste comprises a solder powder and an adhesive. In principle, any of the commercially available solder powders or adhesives can be used in the present invention. The solid content of the solder paste can be from 15 to 60 wt. %, such as, 20 wt. %, 25 wt. %, 30 wt. %, 40 wt. % or 50 wt. %.

According to the present invention, the commercially available BNi-2, BNi-5 or BNi-7 solder pastes may be used. These solder pastes may have a solid content within the scope as mentioned above.

In step a) of the method of the present invention, the solder paste can be applied in a predetermined amount according to the specific use of said metal honeycomb matrix. The specific amount may be determined experimentally beforehand to allow the matrix to have a sufficient welding strength, without reducing the sectional area of cells or resulting in a waste of brazing material due to an excessive amount of solder paste.

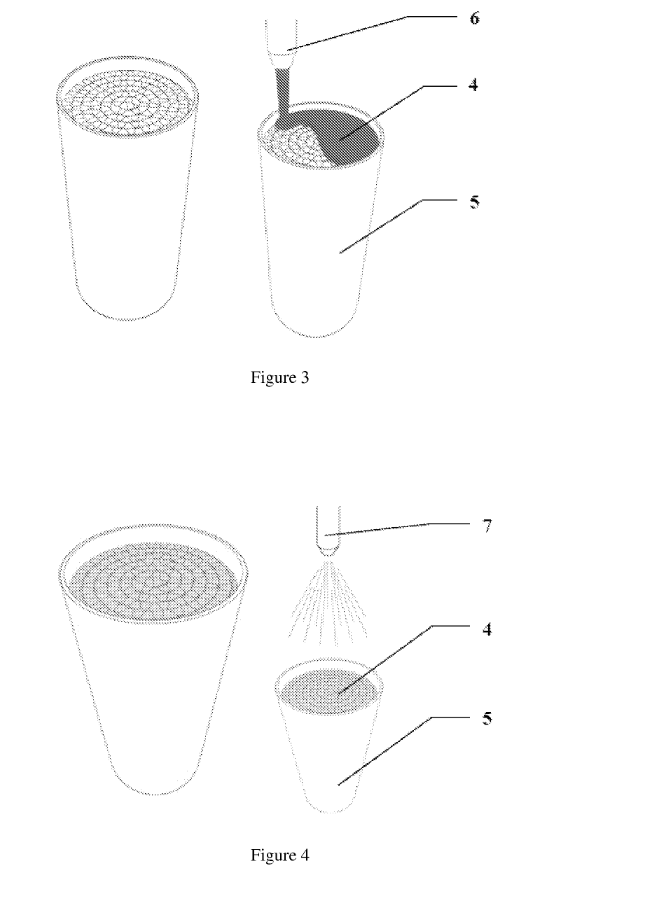

In step a), the solder paste may be applied by coating methods, such as, brush coating, knife coating, wash coating or spray coating, or by using a dispenser or grouter, as shown in FIG. 3. In the present invention, the application of solder paste can be finished at one time, so that the processing steps of the method of the present invention will be more simple and convenient.

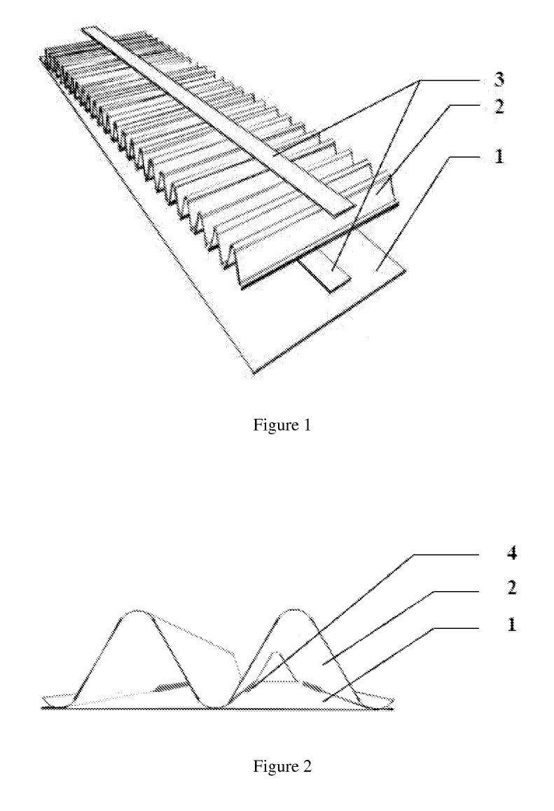

In one embodiment, the solder paste is distributed at the contact joints of the corrugated sheets and smooth sheets and/or the housing by step c). One of the advantages of the method lies in that the solder paste can be mainly distributed at contact joints to be welded, while absent in the areas which do not need welding, so that the reduction of cell sectional area and waste of brazing materials can be avoided, as shown in FIG. 2.

Another advantage of the present invention lies in that, the use of solder paste as the brazing material makes it possible that there is no need to add any brazing material during the process of coiling the honeycomb core. After the honeycomb core is wound up, a certain amount of solder paste is poured into the core (by automatic equipments or manually) to fill the cell channels up with solder paste. Subsequently, the solder moves at an acceleration formed in the axial direction along the cell channels by means of airflow purging (which may be under a high pressure at a high speed) or centrifugation (which may be high-speed centrifugation), and is mainly distributed around the joints of corrugated sheets and smooth sheets as well as those of corrugated sheets and the housing by taking advantage of the non-infiltration characteristics of the paste on metallic surfaces and hydrodynamic balance of the paste near contact joints, making it possible for the highly efficient application of brazing materials.

Therefore, according to a preferred embodiment of the present invention, the step c) is carried out by means of airflow purging or centrifugation.

In order to enable the solder pastes to be distributed in metal honeycomb matrix, the airflow purging may be conducted by blowing the airflow from the end face of the matrix to which the solder paste is applied to the direction of the other end face, as shown in FIG. 4. It is preferred that the airflow purging is carried out for from 2 to 10 seconds, or from 3 to 9 seconds, or from 4 to 7 seconds, under a gas pressure of from 0.2 to 0.6 MPa, or from 0.3 to 0.5 MPa, or from 0.3 to 0.4 MPa, all expressed in gauge pressure. In one embodiment, said airflow may be compressed air.

In one embodiment of adopting the centrifugation method, said centrifugation is conducted for from 2 to 10 seconds, or from 3 to 9 seconds, or from 4 to 7 seconds, at a speed of from 200 to 2000 rpm, or from 500 to 1500 rpm, or from 800 to 1000 rpm.

In the present invention, according to specific applications, the solder paste may be present in the predetermined area of the metal honeycomb matrix. That is to say, the solder paste may be present in the whole length of the metal honeycomb matrix, or in part of the length thereof. The distribution length of solder paste at each welding seam, and the distance between solder paste and end faces may be substantially the same, or mutually different. In the case that both the length of solder paste and distance between solder paste and end faces are the same, the solder paste on the axial section of the metal honeycomb matrix is substantially distributed in a rectangular shape.

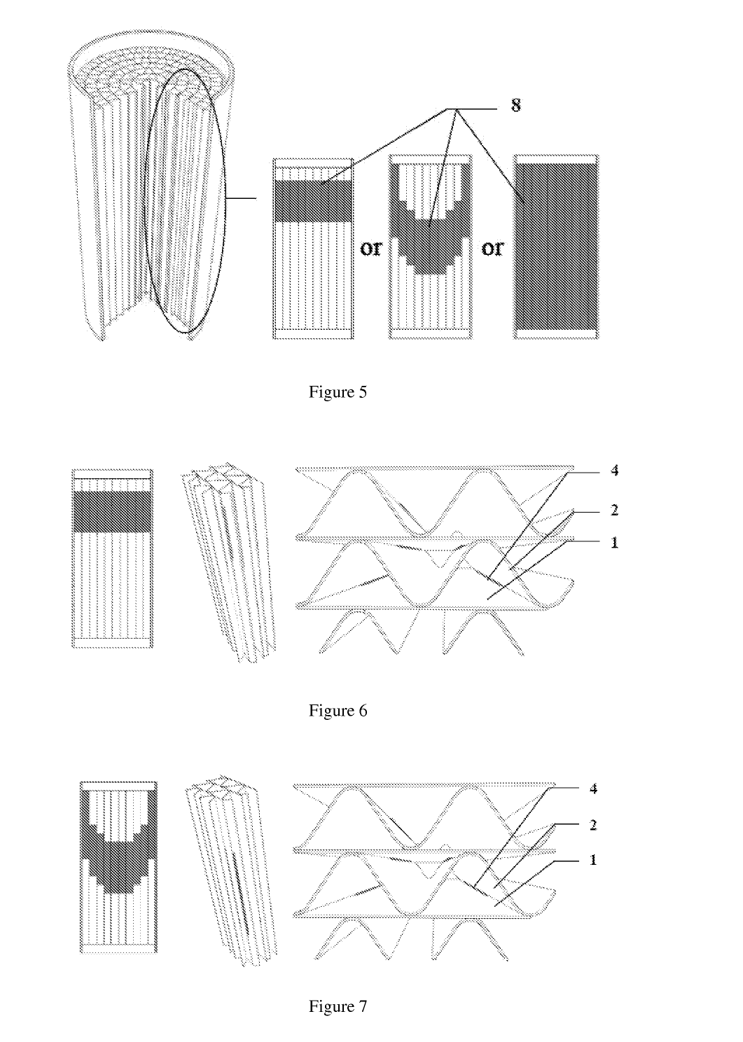

As shown in FIG. 5, in the present invention, the solder paste may be distributed in the single-ended form, in the warhead-like shape or in the form of complete distribution. The single-ended distribution form means that the distance between the distribution location of the solder paste and one end face of the metal honeycomb matrix is no greater than 50% of the length of the metal honeycomb matrix, e.g., no greater than 45%, 40%, 35%, 30%, 25%, 20%, 15%, or 10% of the matrix length. The warhead-like distribution form means that the solder paste is distributed in the axial section of the metal honeycomb matrix in a warhead-like or conical shape. The complete distribution form means that the solder paste is substantially distributed on the whole length of the metal honeycomb matrix, i.e., 90% to 100% of the length of the matrix.

It was discovered by the inventor of the present invention that the heated modes of the metal honeycomb matrices are different when used on different occasions, and thus the thermal stress distribution profiles thereof is also varied. The method of the present invention may enable the solder paste to be distributed in areas prearranged with respect to different application occasions, to reduce the occurrence of cracking solder joints because of thermal stress, to enhance the heat resistance of metal honeycomb matrices, and to extend the service life thereof.

The distribution of solder paste in predetermined areas can be easily achieved by the method of the present invention. For example, when the method of airflow purging or centrifugation is adopted, the solder paste can be distributed in the desired areas by controlling its solid content, pressure and duration of the airflow purging, and/or speed of the centrifuge and the centrifugation time, and the like. In this aspect, it is preferred that the solid content of solder paste ranges from 15 to 60 wt. %, such as, 20 wt. %, 25 wt. %, 30 wt. %, 40 wt. % or 50 wt. %; the airflow purging is carried out preferably for from 2 to 10 seconds, or from 3 to 9 seconds, or from 4 to 7 seconds under a gas pressure of from 0.2 to 0.6 MPa, or from 0.3 to 0.5 MPa, or from 0.3 to 0.4 MPa gauge pressure; the centrifugation is carried out for from 2 to 10 seconds, or from 3 to 9 seconds, or from 4 to 7 seconds at a speed of from 200 to 2000 rpm, or from 500 to 1500 rpm, or from 800 to 1000 rpm.

The method of the present invention may further comprise a step of precleaning the metal honeycomb matrix prior to step a). Such a step of precleaning may be carried out by widely known methods in the art, such as, ultrasound cleaning, washing with alkali liquor followed by washing with water, and the like.

The method of the present invention may further comprise, between steps a) and c), the following step of b) leaving the metal honeycomb matrix to stand to allow the applied solder paste to move from the end face to which the solder paste was initially applied to the other end face under the action of gravity. In one embodiment, the metal honeycomb matrix is left to stand for from 1 to 30 minutes, e.g., from 3 to 22 minutes, or from 5 to 18 minutes, or from 8 to 15 minutes. During this process, the metal honeycomb matrix can be vertically or obliquely placed.

The second aspect of the present invention relates to a method for manufacturing a metal honeycomb matrix with two open end faces, which contains a metal housing and a metal honeycomb core constructed by stacking and winding up smooth and corrugated metal sheets, comprising the steps of

(1) applying a brazing material to the metal honeycomb matrix according to the aforesaid brazing material applying method and

(2) brazing the metal honeycomb matrix.

All of the technical contents as mentioned in the first aspect of the present invention are also applicable to the second aspect of the present invention, and thus will not be repeated here.

Preferably, the step (2) as mentioned above is carried out by vacuum brazing. More preferably, said vacuum brazing comprises, under the vacuum conditions of from 1*10⁻³ to 2*10⁻² Pa, or from 2*10⁻³ to 1*10⁻² Pa, raising the temperature to from 950 to 1200° C., e.g., from 970 to 1100° C., or from 990 to 1050° C., and maintaining at said temperature for from 10 to 30 minutes, e.g., from 15 to 27 minutes, from 18 to 25 minutes, or 20 minutes.

The third aspect of the present invention relates to the metal honeycomb matrix prepared by the method for manufacturing the same. The metal honeycomb matrix by the present invention possesses advantages of smaller backpressure, better heat-resistance and longer service lifetime compared to the same made by the current technologies.

### EXAMPLES

### Example 1

A metal honeycomb matrix to be perfused with solder paste is constructed by the conventional method reported in the prior art. To be specific, some metal foils are first compressed into corrugated sheets, and then one piece of the smooth sheet and one piece of the corrugated sheet are stacked and fed into a clamping device and coiled into a matrix core in single spiral shape, which is then pushed into the housing to result in an intermediate product to be perfused with solder paste. The so-obtained intermediate product has diameter 042 mm, length 100 mm, and cell density 300 cpsi, and is labeled as 042*100/300 cpsi metal honeycomb. The said intermediate product is cleaned with ultrasonic wave and dried, and then the end face of the vertically placed honeycomb is perfused with the solder paste in a dispensing manner by using the SH-2 type triaxial automatic dispenser produced by Guangdong Sihai Co. Ltd. (vide FIG. 3). The solder paste used is BNi-2, a product produced by Heesung Material LTD with a solid content of 50%. 5 grams of solder paste is applied.

After being left to stand for 2 minutes after perfusion, the matrix is purged downwards with compressed air from the end to which the solder paste was applied (vide FIG. 4). The purging parameters are as follows:

| | |
|---|---|
| Distribution form of solder paste | FIG. 7 (distribution in |
| | warhead-like form) |
| Purging air pressure | 0.6 MPa |
| Purging duration | 5 seconds |

After completion of the purging, the matrix is fed into a vacuum brazing furnace. The temperature is raised to 1050° C. under vacuum ˜10⁻³ Pa, and maintained for 20 minutes.

### Example 2

Following the same procedure to obtain the to-be-solder-paste-perfused metal honeycomb matrix as mentioned in Example 1 but now with different size and shape. The metal honeycomb matrix has diameter Ø62 mm, length _{—}50 mm, and cell density 400 psi with an inner core of S shape, and is labeled Ø62*50/400 cpsi metal honeycomb. It is cleaned with ultrasonic wave and dried, and then the solder paste is poured onto the end face of the vertically placed honeycomb in a grouting manner by using the DG type single-head paste filling machine produced by Guilin Starlight Packing Machinery Co., Ltd. The solder paste used is BNi-5, a product produced by Heesung Material LTD with a solid content of 25%. 5 grams of BNi-5 is used.

After being left to stand for 5 minutes after perfusion, the matrix is put into a centrifuge for centrifugation with the end face with the solder paste being placed inward. The centrifugation parameters are as follows:

| | |
|---|---|
| Distribution form of solder paste | FIG. 8 (complete-distribution) |
| Centrifugation speed | 800 rpm |
| Centrifugation duration | seconds |

After completion of the centrifugation, the matrix is transferred into a vacuum brazing furnace. The temperature is raised to 1200° C. under vacuum ˜10⁻³ Pa and maintained for 20 minutes.

### Example 3

The metal honeycomb matrix to be perfused with paste is constructed in the same way as mentioned in Example 1 but again with different dimensions. The honeycomb metal matrix has diameter Ø35 mm, length 50 mm, and cell density 200 psi and is labeled Ø35*50/200 cpsi metal honeycomb. It is cleaned with ultrasonic wave, and dried, and then the solder paste is poured onto the end face of the vertically placed honeycomb in a grouting manner by using the DG type single-head paste filling machine made by Guilin Starlight Packing Machinery Co., Ltd. (vide FIG. 3). The solder paste used is BNi-7, a product produced by Heesung Material LTD with a solid content of 50%. 5 grams of BNi-7 is applied.

After being left to stand for 2 minutes after perfusion, the matrix is purged downwards with compressed air from the end face with solder paste (vide FIG. 4). The purging parameters are as follows:

| | |
|---|---|
| Distribution form of solder | FIG. 6 (single-ended distribution) |
| Purging air pressure | 0.3 MPa |
| Purging duration | 2 seconds |

After completion of the purging, the matrix is put into a vacuum brazing furnace. The temperature is raised to 980° C. under vacuum ˜10⁻³ Pa, and maintained for 20 minutes.

### Comparative Example

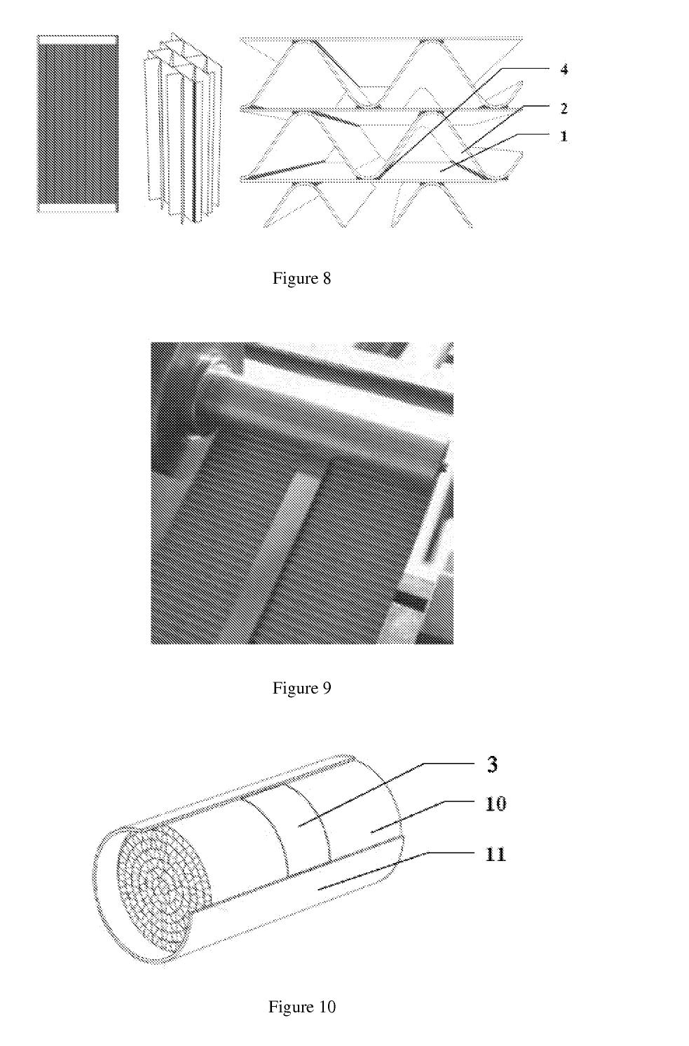

Based on the “Embodiments” on page 2 of the specification of CN2861504Y, a number of metal honeycomb matrices are assembled using BNi-5 brazing strips from Shanghai Shilu Special Metal Materials Co., LTD, and the said matrices have the structure designs as shown in FIG. 10 and the dimensions the same as those in Examples 1, 2 and 3. The assembled matrices are put into a vacuum brazing furnace, and the temperature is raised to 1200° C. under vacuum ˜10⁻³ Pa, and maintained for 20 minutes to complete the brazing.

Performance Test and Comparison 1

The metal honeycombs in Example 1 and Comparison Example are washcoated with catalyst by conventional dip-coating method, and the coated catalysts are dried and calcined. The ratio of the noble metals Pt and Rh in the catalysts is 5/1, with a total noble metal content of 50 g/ft³.

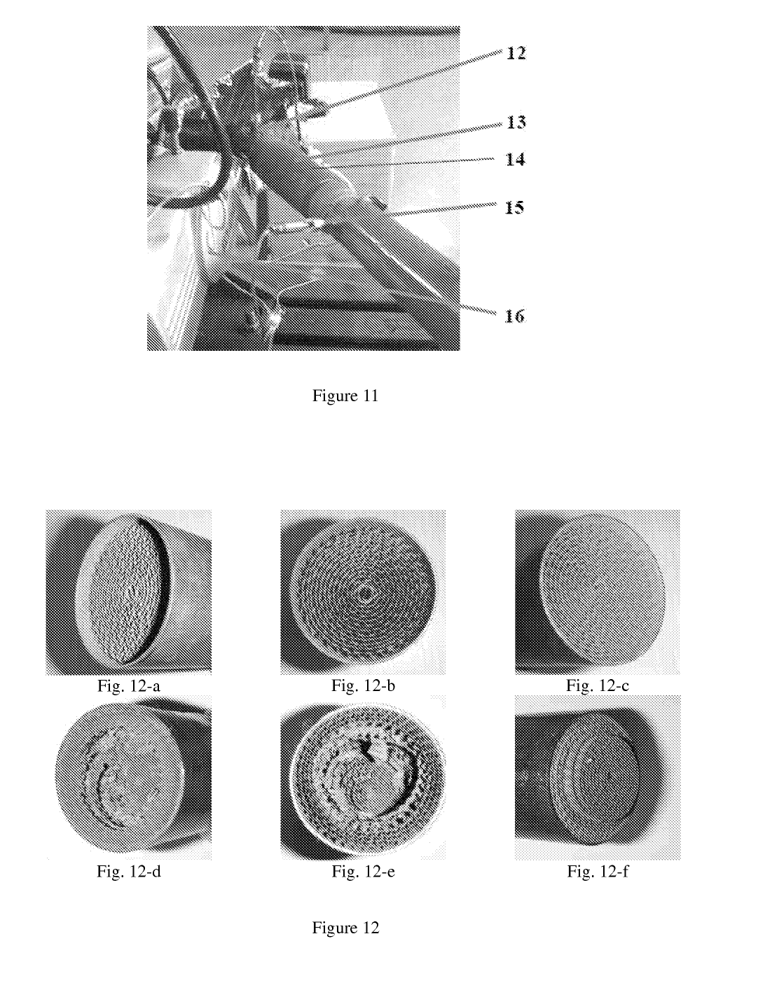

The catalysts are installed in a specific reactor as shown in FIG. 11. Since a YAMAHA NY125 two-stroke 124 cc engine is employed in the test, a rather high catalyst bed temperature and drastic temperature change can be reached due to the catalytic reactions. In the test, the engine discharge temperature in front of the catalysts, catalyst central bed temperature, and airflow temperature behind the catalysts are monitored.

Temperature ranges at which the test proceeds are recorded as follows:

| | Engine | | |
|---|---|---|---|
| | discharge | Catalyst central bed | Airflow temperature |
| | temperature | temperature | behind catalyst |
| Sample of | 650~720° C. | 1000~1150° C. | 880~930° C. |
| Example 1 | | | |
| Sample of | 650~720° C. | 1000~1150° C. | 880~930° C. |
| Comparative | | | |
| Example | | | |

The engine is stopped after every 4.5 hour running to check the sample condition. The sample of Example 1 of the present invention still has an intact structure after 5 times of the endurance cycle of 4.5 hours (i.e., 22.5 hours), while the sample in Comparative Example is confirmed to be severely structurally damaged after the first cycle of 4.5-hour endurance test (vide FIG. 12).

It is evidence that, under the same severe operational conditions for catalysts, the honeycomb of the present invention has a longer service lifetime.

Performance Test and Comparison 2

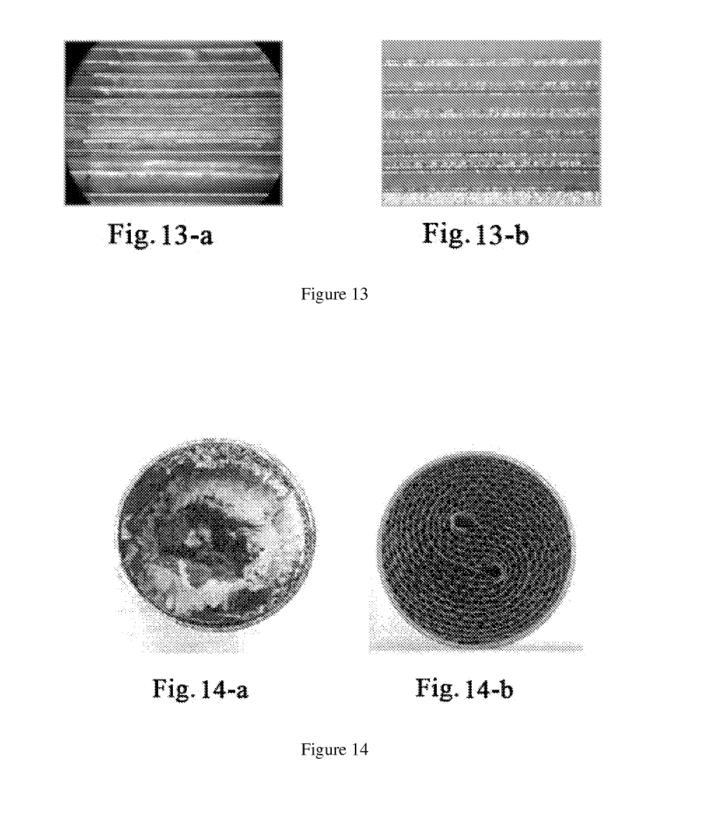

The metal honeycombs of Example 2 and the corresponding Comparative Example are cut open along the axial direction (vide FIG. 13).

It can be seen that the solder is uniformly distributed at the welding seams for the metal honeycombs in Example 2, while the solder for those in the Comparative Example is distributed over the whole surface.

The metal honeycombs of Example 2 and Comparison Example are washcoated with catalyst by conventional dip-coating method, and the coated catalysts are dried and calcined. The ratio of the noble metals Pt, Pd and Rh in the catalysts is 1/18/1, with a total noble metal content of 50 g/ft³.

The catalyst is encapsulated in a 1P90/420 cc universal machine muffler, and is subjected to the endurance test under the condition of rated speed and full load. The result is as follows: after a 125-hour test, the Comparative Example has been damaged, while the structure of Example 2 is still in good condition after a 250-hour test. Vide FIG. 14.

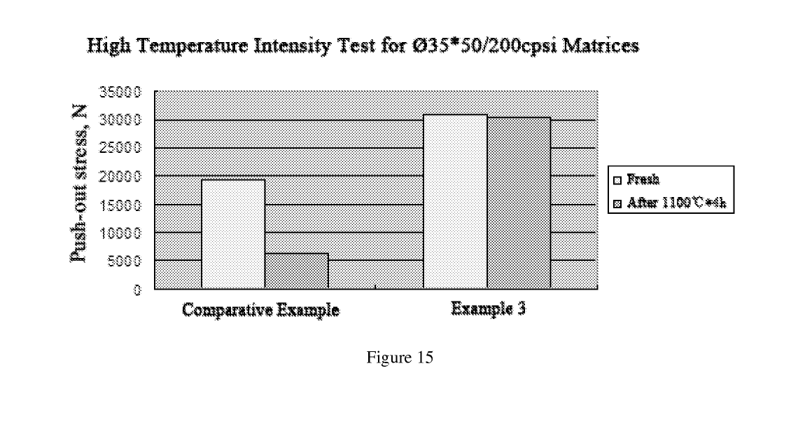

Performance Test and Comparison 3 The metal honeycombs in Example 3 and the corresponding Comparative Example are placed in a Muffle furnace, removed after 4-hour at 1100° C., cooled down to room temperature, and subjected to a push-out pressure test. This test is mainly for examining the changes of mechanical strength of the matrix after being exposed to high temperatures. The result is shown in FIG. 15. It is manifest that Example 3 is obviously advantageous in resistance to high temperatures.

1. A method for applying a brazing material to a metal honeycomb matrix with two open end faces, which contains a metal housing and a metal honeycomb core constructed by stacking and winding up smooth and corrugated metal sheets, comprising the steps of
a) applying the brazing material in a form of a solder paste to one open end face of the metal honeycomb matrix; and
c) distributing the solder paste in the metal honeycomb matrix.

2. The method according to claim 1, wherein the solder paste is applied in a predetermined amount in step a).

3. The method according to claim 1, wherein the solder paste is applied by coating, brush coating, knife coating, wash coating, spray coating, or by using a dispenser or grouter in step a).

4. The method according to claim 1, wherein the solder paste is distributed in the contact joints of the corrugated sheets and smooth sheets and/or the housing by said step c).

5. The method according to claim 1, wherein the solder paste is present in a predetermined area in the metal honeycomb matrix.

6. The method according to claim 1, wherein the step c) is carried out by means of airflow purging or centrifugation.

7. The method according to claim 6, wherein the airflow purging is carried out by using compressed air.

8. The method according to claim 6, wherein the airflow purging is carried out for from 2 to 10 seconds under a gas pressure of from 0.2 to 0.6 MPa gauge pressure.

9. The method according to claim 6, wherein the centrifugation is carried out for from 2 to 10 seconds at a speed of from 200 to 2000 rpm.

10. The method according to claim 1, wherein the solder paste is distributed in single-ended form, in warhead-like form or in a form of complete distribution.

11. The method according to claim 1, further comprising a step of precleaning the metal honeycomb matrix prior to step a).

12. The method according to claim 1, further comprising, between steps a) and c), the following step of:
b) leaving the metal honeycomb matrix to stand, allowing the applied solder paste to move from the end face to which the solder paste was initially applied to the other end face under the action of gravity.

13. The method according to claim 12, wherein the metal honeycomb matrix is left to stand for from 1 to 30 minutes in step b).

14. The method according to claim 12, wherein the metal honeycomb matrix is placed vertically or obliquely in step b).

15. The method according to claim 1, wherein said solder paste comprises a solder powder and an adhesive, and has a solid content of from 15 to 60 wt.

16. The method according to claim 1, wherein said solder paste is BNi-2, BNi-5 or BNi-7 or other mushy brazing materials.

17. A method for manufacturing a metal honeycomb matrix with two open end faces, which contains a metal housing and a metal honeycomb core constructed by stacking and winding up smooth and corrugated metal sheets, comprising the steps of
(1) applying a brazing material to the metal honeycomb matrix according to the method according to claim 1; and
(2) brazing the metal honeycomb matrix comprising the brazing material.

18. The method according to claim 17, wherein the step (2) is carried out by vacuum brazing.

19. The method according to claim 18, wherein said vacuum brazing comprises raising the temperature to from 950 to 1200 C and maintaining at said temperature for from 10 to 30 minutes under the vacuum condition of from 1*10⁻³ to 2*10⁻² Pa.

20. A metal honeycomb matrix prepared by the method according to claim 17.
